(19) United States
(12) Patent Application Publication
(10) Pub. No.: US 2006/0101270 A1
(43) Pub. Date: May 11, 2006

(54) Determining a key derivation function

(75) Inventor: Pekka Laitinen, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/249,311

(22) Filed: Oct. 14, 2005

(30) Foreign Application Priority Data
Nov. 9, 2004 (FI) 20041447

(51) Int. Cl. H04L 9/00

(52) U.S. Cl. 713/176

(57) ABSTRACT

Methods, user equipment, a bootstrapping server function and computer programs determine a key derivation function to be used by user equipment. The user equipment sends an authentication request to a bootstrapping server function. The bootstrapping server function sends a key derivation function identifier along with a bootstrapping transaction identifier to the user equipment. Based on the key derivation function identifier, the user equipment is able to determine which key derivation function to use.

### BACKGROUND OF THE INVENTION

1. Field of the Invention

The present invention relates to telecommunication systems. In particular, the present invention relates to novel and improved methods, network entities and computer program products for determining a key derivation function to be used by user equipment.

2. Description of the Related Art

The current development towards truly mobile computing and networking has brought on the evolution of various access technologies, which also provide the users with access to the Internet when they are outside their own home network. So far, the use of the Internet has been dominated by person-to-machine communications, i.e. information services. The evolution towards the so-called third generation (3G) wireless networks brings along mobile multimedia communications, which will also change the way IP-based services are utilized in public mobile networks. The IP Multimedia Subsystem (IMS), as specified by the by the 3^{rd} Generation Partnership Project (3GPP), integrates mobile voice communications with Internet technologies, allowing IP-based multimedia services to be utilized in mobile networks.

The new multimedia capable mobile terminals (multimedia phones) provide an open development platform for application developers, allowing independent application developers to design new services and applications for the multimedia environment. The users may, in turn, download the new applications/services to their mobile terminals and use them therein.

Technical Specification 3GPP TS 33.220 discloses the Generic Bootstrapping Architecture (GBA) of the Generic Authentication Architecture (GAA). A general network model of the GBA is disclosed in FIG. 1. The model disclosed in FIG. 1 includes four different entities: User Equipment (UE) 14, a Bootstrapping Server Function (BSF) 12, a Network Application Function (NAF) 16 and a Home Subscriber System (HSS) 10. FIG. 1 also discloses the interfaces between the entities.

FIG. 2 is a diagram that illustrates bootstrapping procedure in the GBA. When UE 200 wants to interact with a NAF, and it knows that the bootstrapping procedure is needed, it shall first perform a bootstrapping authentication. When the bootstrapping is initiated, UE 200 sends (21) an HTTP (Hypertext Transfer Protocol) request towards BSF 202. BSF 202 retrieves (22) the complete set of GBA user security settings and one or a whole batch of Authentication Vectors (AV, AV=RAND∥AUTN∥XRES∥CK∥IK) over the reference point Zh from a HSS 204. Then BSF 202 forwards the RAND and AUTN to UE 200 in the 401 message (23) (without the CK, IK and XRES). This is to demand UE 200 to authenticate itself. UE 200 checks (24) AUTN to verify that the challenge is from an authorized network. UE 200 also calculates CK, IK and RES. This will result in session keys IK and CK in both BSF 202 and UE 200. UE 200 sends (25) another HTTP request, containing the Digest AKA response (calculated using RES), to BSF 202. BSF 202 authenticates (26) UE 200 by verifying the Digest AKA response and generates (27) key material Ks by concatenating CK and IK. A B-TID value shall be also generated. BSF 202 sends (28) a 200 OK message, including the B-TID, to UE 200 to indicate the success of the authentication. In addition, in the 200 OK message, BSF 202 shall supply the lifetime of the key Ks. The key material Ks is generated in UE 200 by concatenating CK and IK. Both UE 200 and BSF 202 shall use the Ks to derive the key material Ks_NAF. Ks_NAF shall be used for securing the reference point Ua (see FIG. 1).

Ks_NAF is computed as Ks_NAF=KDF (Ks, key derivation parameters), where KDF is a suitable key derivation function, and the key derivation parameters consist of the user's private identity (IMPI, IP Multimedia Private Identity), the NAF_Id and RAND. The NAF_Id consists of the full DNS name of the NAF. KDF shall be implemented in the mobile equipment.

A problem in the current architecture is that it does not take into account the fact that a key derivation function in user equipment may need to be changed for some reason, for example, when the key derivation function has been compromised.

### SUMMARY OF THE INVENTION

In 3GPP GAA, only a single key derivation function is being standardized but in the future the user equipment (and the bootstrapping server function) may have support for multiple key derivation functions. In the case where there is a possibility to have multiple key derivation functions it is the bootstrapping server function that decides which key derivation function to use but the problem in the GAA specifications is that there is no way for the bootstrapping server function to communicate the chosen key derivation function to the user equipment.

According to one aspect of the invention there is provided a method for determining a key derivation function to be used by user equipment. The method comprises sending an authentication request to a bootstrapping server function and receiving a key derivation function identifier along with a bootstrapping transaction identifier from the bootstrapping server function.

In one embodiment of the invention, the method further comprises selecting a key derivation function corresponding to the key derivation function identifier from a key derivation function memory and using the key derivation function identified by the key derivation function identifier.

In one embodiment of the invention, the method further comprises receiving a retrieval address for a key derivation function from the bootstrapping server function along with the key derivation function identifier.

In one embodiment of the invention, the method further comprises sending a request for the key derivation function to the retrieval address, receiving the key derivation function, storing the key derivation function in a key derivation function memory, and using the key derivation function identified by the key derivation function identifier.

In one embodiment of the invention, the method further comprises replacing a prior key derivation function with the key derivation function in the key derivation function memory.

According to another aspect of the invention there is provided a method for determining a key derivation function to be used by user equipment. The method comprises receiving an authentication request from user equipment and sending a key derivation function identifier along with a bootstrapping transaction identifier to the user equipment in response to the authentication request.

In one embodiment of the invention, the method further comprises sending a retrieval address for the key derivation function to the user equipment along with the key derivation function identifier.

In one embodiment of the invention, the method further comprises receiving a key derivation function update from a key derivation function update entity.

According to another aspect of the invention there is provided user equipment for using a key derivation function. The user equipment comprises a transmitter configured to send an authentication request to a bootstrapping server function, a receiver configured to receive a key derivation function identifier along with a bootstrapping transaction identifier from the bootstrapping server function, and a key derivation function memory configured to store at least one key derivation function.

In one embodiment of the invention, the user equipment comprises a processing unit configured to select a key derivation function corresponding to the key derivation function identifier from a key derivation function memory and to use the key derivation function identified by the key derivation function identifier.

In one embodiment of the invention, the receiver is configured to receive a retrieval address for the key derivation function from the bootstrapping server function along with the key derivation function identifier.

In one embodiment of the invention, the transmitter is configured to send a request for the key derivation function to the retrieval address, the receiver is configured to receive the key derivation function, a processing unit is configured to store the key derivation function in the key derivation function memory, and the processing unit is configured to use the key derivation function identified by the key derivation function identifier.

In one embodiment of the invention, the processing unit is configured to replace a prior key derivation function with the key derivation function in the key derivation function memory.

According to another aspect of the invention there is provided a bootstrapping server function for determining a key derivation function. The bootstrapping server function comprises a receiver configured to receive an authentication request from user equipment, a processing unit configured to determine a key derivation function to be used, and a transmitter configured to send a key derivation function identifier of the key derivation function along with a bootstrapping transaction identifier to the user equipment.

In one embodiment of the invention, the transmitter is configured to send a retrieval address for the key derivation function to the user equipment along with the key derivation function identifier.

In one embodiment of the invention, the receiver is configured to receive a key derivation function update from a key derivation function update entity.

According to another aspect of the invention there is provided a computer program embodied on a computer-readable medium to determine a key derivation function, said program configured to perform the following steps when executed on a data-processing device: sending an authentication request to a bootstrapping server function, and receiving a key derivation function identifier along with a bootstrapping transaction identifier from the bootstrapping server function.

In one embodiment of the invention, said program is configured to perform the following steps when executed on a data-processing device: selecting a key derivation function corresponding to the key derivation function identifier from a key derivation function memory, and using the key derivation function identified by the key derivation function identifier.

In one embodiment of the invention, said program is configured to perform the following step when executed on a data-processing device: receiving a retrieval address for the key derivation function from the bootstrapping server function along with the key derivation function identifier.

In one embodiment of the invention, said program is configured to perform the following steps when executed on a data-processing device: sending a request for the key derivation function to the retrieval address, receiving the key derivation function, storing the key derivation function in the key derivation function memory, and using the key derivation function identified by the key derivation function identifier.

In one embodiment of the invention, said program is configured to perform the following step when executed on a data-processing device: substituting a prior key derivation function with the key derivation function in the key derivation function memory.

According to another aspect of the invention there is provided a computer program embodied on a computer-readable medium to determine a key derivation function, said program configured to perform the following steps when executed on a data-processing device: receiving an authentication request from user equipment, and sending a key derivation function identifier along with a bootstrapping transaction identifier to the user equipment in response to the authentication request.

In one embodiment of the invention, said program is configured to perform the following step when executed on a data-processing device: sending a retrieval address for the key derivation function to the user equipment along with the key derivation function identifier.

In one embodiment of the invention, said program is configured to perform the following step when executed on a data-processing device: receiving a key derivation function update from a key derivation function update entity.

According to another aspect of the invention there is provided a system for determining a key derivation function. The system comprises sending means for sending an authentication request to a bootstrapping server function, and receiving means for receiving a key derivation function identifier along with a bootstrapping transaction identifier from the bootstrapping server function.

According to another aspect of the invention there is provided a system for determining a key derivation function. The system comprises receiving means for receiving an authentication request from a user equipment, and sending means for sending a key derivation function identifier along with a bootstrapping transaction identifier to the user equipment in response to the authentication request.

The present invention has several advantages over the prior-art solutions. If user equipment is pre-installed with multiple key derivation functions, it is easier to switch to another key derivation function if the most used one has been compromised as no UE (either UICC (Universal Integrated Circuit Card) cards or Mobile Equipment (ME)) need to be replaced. The invention also provides a solution to indicate a key derivation function if the user equipment is updated with one or more new key derivation functions (and not replacing the existing key derivation function) or otherwise contains multiple key derivation functions.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram illustrating a prior art architecture of the Generic Bootstrapping Architecture (GBA),

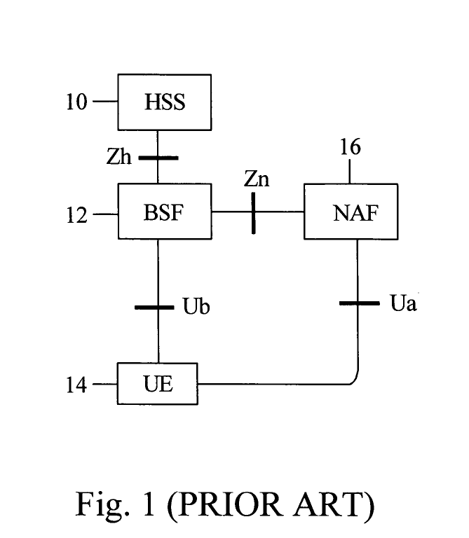

FIG. 2 is a signaling diagram illustrating a prior art bootstrapping procedure,

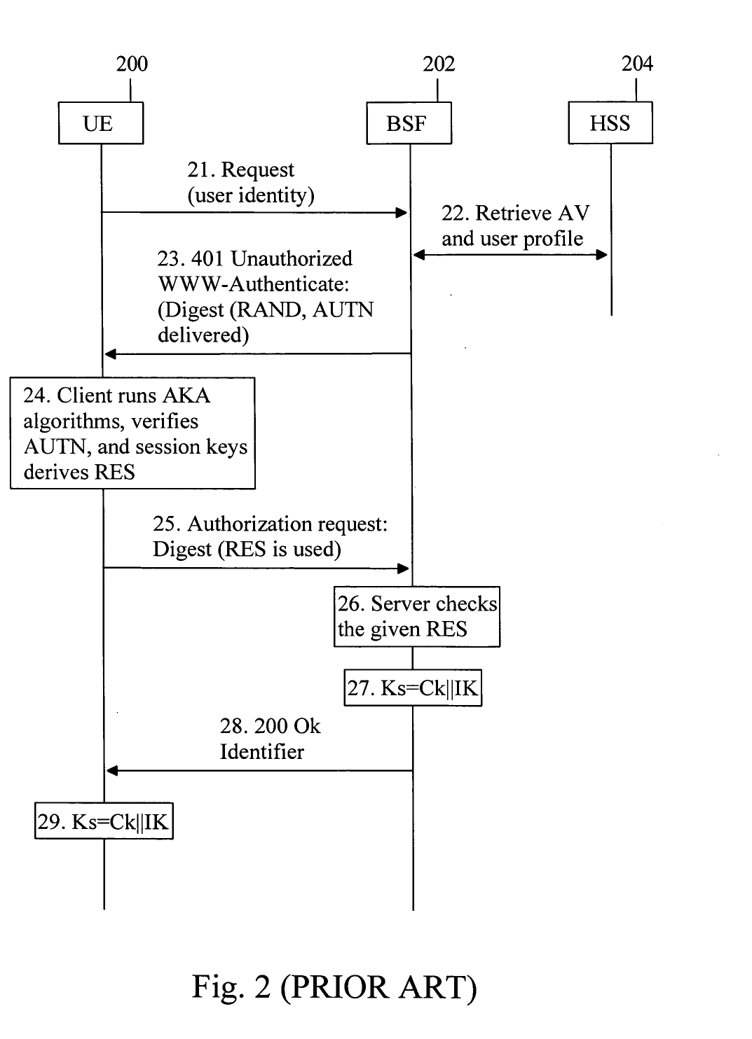

FIG. 3 is a flow diagram illustrating a method according to the invention, and

FIG. 4 is a block diagram illustrating one embodiment of user equipment and bootstrapping server function according to the invention.

### DETAILED DESCRIPTION OF THE PREFERRED EMBODIMENTS

Reference will now be made in detail to the embodiments of the present invention, examples of which are illustrated in the accompanying drawings.

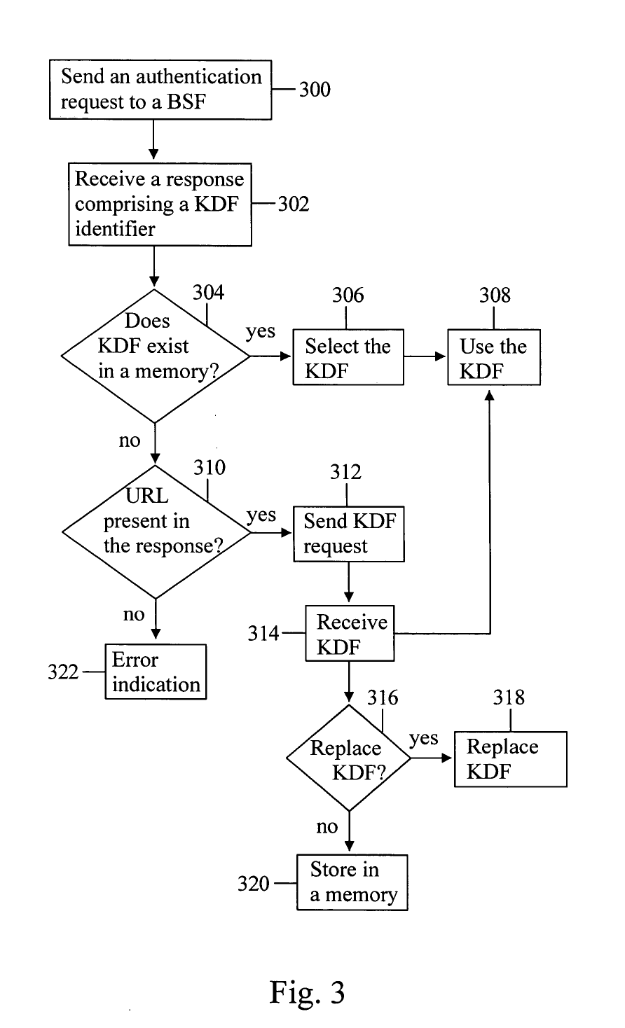

FIG. 3 in general illustrates the possibility to update or replace the key derivation function in the General Bootstrapping Architecture (GBA). The need for replacing the function might be that the existing function used in the GBA is compromised and significantly reduces the security of the GBA. Also, an operator may want to define a new key derivation function and customize the user equipment to use the customized key derivation function instead of the default one.

User equipment sends (300) an authentication request to a bootstrapping server function. In response to the request, the user equipment receives (302) a key derivation function (KDF) identifier along with a bootstrapping transaction identifier (B-TID) from the bootstrapping server function.

Before step 302, the bootstrapping server function may receive an indication from operator's management system to change the key derivation function used. After this the bootstrapping server function indicates (step 302) a key derivation identifier of the changed key derivation function (the new key derivation function) to the user equipment according to the instructions received from the management system.

The user equipment determines (304) whether the key derivation function identified by the key derivation identifier exists in a key derivation function memory. The user equipment may be pre-installed with multiple key derivation functions. The user equipment then selects (306) the key derivation function corresponding to the key derivation function identifier and uses (308) it when needed, if the key derivation function exists in the memory.

Another alternative is that the user equipment does not comprise the key derivation function corresponding to the key derivation function identifier. In that case the user equipment may determine (310) whether an optional retrieval address was received along with the key derivation function identifier. If the retrieval address is available, the user equipment sends (312) a key derivation function request to that address. If the retrieval address is not available (322), the user equipment may optionally indicate an error condition to the bootstrapping server function, and abort the procedure.

The user equipment receives (314) the key derivation function in response to the request. Therefore, in this alternative the key derivation function is updated e.g. using the OTA (Over The Air) interface, where the key derivation function implementation itself, or an address (e.g. Uniform Resource Location (URL)) to the key derivation function implementation is sent the user equipment by an operator's OTA server. In the latter case, the user equipment fetches the key derivation function implementation from the resource indicated in the URL. The resource could be, for example, a HTTP scheme where the user equipment fetches a digitally signed key derivation function implementation from a web server using the HTTP. An operator may use the URL e.g. in a case in which it wants to update all the user equipment of its customers. The OTA interface has been defined by the Open Mobile Alliance (OMA) standardization forum.

The received key derivation function may replace (316 and 318) the previously used key derivation function if it is not possible to store several key derivation functions in the user equipment. If the user equipment allows storing more than one key derivation function, the received key derivation function is stored (320) in a key derivation function memory. It may also replace one of the existing key derivation functions in the memory.

When user equipment is pre-installed with multiple key derivation functions, an operator avoids a massive update procedure if it wants to take a new key derivation function into use. The bootstrapping server function may indicate the key derivation function to be used when deriving keys from Ks by sending an algorithm identifier identifying the key derivation along side with the B-TID and key lifetime over the Ub reference point. With the possibility to update the key derivation function from the network, the operator may introduce a completely new key derivation function.

The indication of the key derivation function over the Ub reference point does not cause any security vulnerabilities. Firstly, if an attacker manages to change the key derivation function indication this can be detected because of the integrity protection provided by Ub reference point. Secondly, a changed key derivation function merely results into a denial-of-service attack, because the user equipment and the bootstrapping server function would use different key derivation functions and the Ks_NAF used in the user equipment and in the network application function (NAF) would be different, that is, authentication would fail. It should be noted that if an attacker is able to change the B-TID value, this would result to the same denial-of-attack as the network application function would use the wrong B-TID when fetching the Ks_NAF from the bootstrapping server function.

It may also be possible that an external update entity, e.g. an operator, indicates via the OTA interface to the user equipment that a key derivation function is to be updated. The key derivation function is updated in the user equipment, and the received key derivation function may replace one of the existing key derivation functions, or it may be just added to the list key derivation functions the user equipment has.

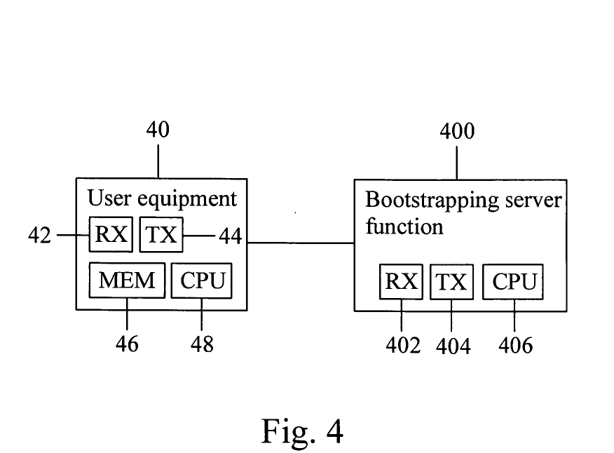

FIG. 4 is a block diagram illustrating one embodiment of user equipment 40 and a bootstrapping server function 400 according to the invention. The user equipment 40 comprises a transmitter 44 configured to send an authentication request to the bootstrapping server function 400, a receiver 42 configured to receive a key derivation function identifier along with a bootstrapping transaction identifier (B-TID) from the bootstrapping server function 400 and a key derivation function memory 46 configured to store at least one key derivation function. The user equipment 40 further comprises a processing unit 48 configured to select a key derivation function corresponding to the key derivation identifier from the key derivation function memory 46 and to use the key derivation function identified by the key derivation function identifier.

In one embodiment, the receiver 42 may also be configured to receive a retrieval address for the key derivation function from the bootstrapping server function 400 along with the key derivation function identifier. The transmitter 44 may then send a request for the key derivation function to the retrieval address and the receiver 42 is configured to receive the requested key derivation function. If the received key derivation function is to replace the existing key derivation function, the processing unit 48 is configured to use the received key derivation function from now on.

If user equipment 42 is able to store several key derivation functions, the received key derivation function may replace one of the existing key derivation functions, or it may be just added to the list key derivation functions the user equipment 42 has. In one embodiment, the user equipment 42 comprises mobile equipment (ME) and a UICC. The key derivation function memory 46 may then reside in either of them.

The bootstrapping server function 400 comprises a receiver 402 configured to receive an authentication request from user equipment 40, a processing unit 406 configured to determine a key derivation function to be used and a transmitter 404 configured to send a key derivation function identifier along with a bootstrapping transaction identifier to the user equipment 40. In one embodiment, the transmitter 404 is further configured to send a retrieval address for the key derivation function to the user equipment 40 along with the key derivation function identifier. The receiver 402 may also receive a key derivation function update from a key derivation function update entity, that is, when the key derivation function is to be updated in the user equipment 40.

The user equipment 40 and the bootstrapping server function 400 may also include additional memory or memories (not disclosed in FIG. 4) that also include other applications or software components. The memory or memories may also include a computer program (or portion thereof), which when executed on the processing unit 48 or 406 performs at least some of the steps of the invention. The processing unit 48 or 406 may also include memory or a memory may be associated therewith which may include the computer program (or portion thereof) which when executed on the processing unit 48 or 406 performs at least some of the steps of the invention.

It is obvious to a person skilled in the art that with the advancement of technology, the basic idea of the invention may be implemented in various ways. The invention and its embodiments are thus not limited to the examples described above, instead they may vary within the scope of the claims.

1. A method for determining a key derivation function to be used by user equipment, the method comprising:
sending an authentication request to a bootstrapping server function; and
receiving a key derivation function identifier along with a bootstrapping transaction identifier from the bootstrapping server function.

2. The method according to claim 1, further comprising:
selecting a key derivation function corresponding to the key derivation function identifier from a key derivation function memory; and
using the key derivation function identified by the key derivation function identifier.

3. The method according to claim 1, further comprising:
receiving a retrieval address for a key derivation function from the bootstrapping server function along with the key derivation function identifier.

4. The method according to claim 3, further comprising:
sending a request for the key derivation function to the retrieval address;
receiving the key derivation function;
storing the key derivation function in a key derivation function memory; and
using the key derivation function identified by the key derivation function identifier.

5. The method according to claim 4, further comprising:
replacing a prior key derivation function with the key derivation function in the key derivation function memory.

6. A method for determining a key derivation function to be used by user equipment, the method comprising:
receiving an authentication request from user equipment; and
sending a key derivation function identifier along with a bootstrapping transaction identifier to the user equipment in response to the authentication request.

7. The method according to claim 6 further comprising:
sending a retrieval address for the key derivation function to the user equipment along with the key derivation function identifier.

8. The method according to claim 6 further comprising:
receiving a key derivation function update from a key derivation function update entity.

9. User equipment for using a key derivation function, the user equipment comprising:
a transmitter configured to send an authentication request to a bootstrapping server function;
a receiver configured to receive a key derivation function identifier along with a bootstrapping transaction identifier from the bootstrapping server function; and
a key derivation function memory configured to store at least one key derivation function.

10. The user equipment according to claim 9 further comprising:
a processing unit configured to select a key derivation function corresponding to the key derivation function identifier from the key derivation function memory and to use the key derivation function identified by the key derivation function identifier.

11. The user equipment according to claim 9 wherein the receiver is configured to receive a retrieval address for the key derivation function from the bootstrapping server function along with the key derivation function identifier.

12. The user equipment according to claim 11, wherein:
the transmitter is configured to send a request for the key derivation function to the retrieval address;
the receiver is configured to receive the key derivation function;
a processing unit is configured to store the key derivation function in the key derivation function memory; and
the processing unit is configured to use the key derivation function identified by the key derivation function identifier.

13. The user equipment according to claim 12, wherein the processing unit is configured to replace a prior key derivation function with the key derivation function in the key derivation function memory.

14. A bootstrapping server function for determining a key derivation function, the boot strapping server function comprising:
a receiver configured to receive an authentication request from user equipment;
a processing unit configured to determine a key derivation function to be used; and
a transmitter configured to send a key derivation function identifier of the key derivation function along with a bootstrapping transaction identifier to the user equipment.

15. The bootstrapping server function according to claim 14, wherein the transmitter is configured to send a retrieval address for the key derivation function to the user equipment along with the key derivation function identifier.

16. The bootstrapping server function according to claim 14, wherein the receiver is configured to receive a key derivation function update from a key derivation function update entity.

17. A computer program embodied on a computer-readable medium to determine a key derivation function, said program configured to perform the following steps when executed on a data-processing device:
sending an authentication request to a bootstrapping server function; and
receiving a key derivation function identifier along with a bootstrapping transaction identifier from the bootstrapping server function.

18. The computer program according to claim 17, said program configured to perform the following steps when executed on a data-processing device:
selecting a key derivation function corresponding to the key derivation function identifier from a key derivation function memory; and
using the key derivation function identified by the key derivation function identifier.

19. The computer program according to claim 17, said program configured to perform the following step when executed on a data-processing device:
receiving a retrieval address for the key derivation function from the bootstrapping server function along with the key derivation function identifier.

20. The computer program according to claim 19, said program configured to perform the following steps when executed on a data-processing device:
sending a request for the key derivation function to the retrieval address;
receiving the key derivation function;
storing the key derivation function in the key derivation function memory; and
using the key derivation function identified by the key derivation function identifier.

21. The computer program product according to claim 20, said program configured to perform the following step when executed on a data-processing device:
replacing a prior key derivation function with the key derivation function in the key derivation function memory.

22. A computer program embodied on a computer-readable medium to determine a key derivation function, said program configured to perform the following steps when executed on a data-processing device:
receiving an authentication request from user equipment; and
sending a key derivation function identifier along with a bootstrapping transaction identifier to the user equipment in response to the authentication request.

23. The computer program according to claim 22, said program configured to perform the following step when executed on a data-processing device:
sending a retrieval address for the key derivation function to the user equipment along with the key derivation function identifier.

24. The computer program according to claim 22, said program configured to perform the following step when executed on a data-processing device: receiving a key derivation function update from a key derivation function update entity.

25. A system for determining a key derivation function, the system comprising:
sending means for sending an authentication request to a bootstrapping server function; and
receiving means for receiving a key derivation function identifier along with a bootstrapping transaction identifier from the bootstrapping server function.

26. A system for determining a key derivation function, the system comprising:
receiving means for receiving an authentication request from a user equipment; and
sending means for sending a key derivation function identifier along with a bootstrapping transaction identifier to the user equipment in response to the authentication request.
